(19) United States
(12) Patent Application Publication
(10) Pub. No.: US 2026/0012291 A1
(43) Pub. Date: Jan. 8, 2026

(54) ELR PPDU Retransmission with Chase Combining

(71) Applicant: Apple Inc., Cupertino, CA (US)

(72) Inventors: Yan ZHANG, Palo Alto, CA (US); Wook Bong LEE, San Jose, CA (US); Morteza MEHRNOUSH, Hayward, CA (US); Anuj BATRA, Redwood City, CA (US); Abdel Karim AJAMI, San Jose, CA (US); Kanke WU, Mountain View, CA (US); Tianyu WU, Monterey, CA (US)

(21) Appl. No.: 19/254,206

(22) Filed: Jun. 30, 2025

Related U.S. Application Data
(60) Provisional application No. 63/667,479, filed on Jul. 3, 2024.

(51) Int. Cl. H04L 1/00; H04L 1/1812; H04L 5/00

(52) U.S. Cl. CPC H04L 1/0061; H04L 1/0008; H04L 1/1812; H04L 5/0053

(57) ABSTRACT

An apparatus configured to generate an initial transmission including a first enhanced long range (ELR) physical layer (PHY) protocol data unit (PPDU) comprising a first preamble and a first data frame (ELR PPDU), the first ELR PPDU encoded by forward error correction (FEC) encoding, mapped to orthogonal frequency division multiplexing (OFDM) symbols, and duplicated multiple times over multiple resource units (RU) within a channel bandwidth, detect a first block acknowledgment (BA) frame indicating at least part of the initial transmission was not properly decoded and generate a first retransmission including a second ELR PPDU comprising a second preamble and a second data frame corresponding to the first data frame, the second preamble indicating the first retransmission to indicate that a receiver decoding the first retransmission combines soft bits stored from the initial transmission with soft bits from the first retransmission during decoding.

### PRIORITY/INCORPORATION BY REFERENCE

This application claims priority to U.S. Provisional Application Ser. No. 63/667,479 filed on Jul. 3, 2024, and entitled “ELR PPDU Retransmission with Chase Combining,” the entirety of which is incorporated by reference herein.

### BACKGROUND

A wireless local area network (WLAN) may refer to a network that operates in accordance with any of a plurality of different types of protocols, including but not limited to, Institute of Electrical and Electronics Engineers (IEEE) 802.11 wireless communications. The 802.11bn standard, referred to as ultra-high reliability (UHR), is in development.

Enhanced long range (ELR) has been introduced in 802.11bn to support data rates of ˜1.5 Mbps and ˜3 Mbps. These data rates may be achieved by duplicating BSPK/QPSK modulated symbols (rate 1/2 FEC code) four times over four 52-tone resource units (RU) within a 20 MHz bandwidth. At the receiver side, log-likelihood ratio (LLR) metrics are calculated for each of the four duplicated code bits and combined for signal to noise ratio (SNR) enhancement. Frequency diversities may be further harvested with LLR combining for a fading channel.

### SUMMARY

Some example embodiments are related to an apparatus having processing circuitry coupled to memory, wherein the processing circuitry is configured to generate an initial transmission including a first enhanced long range (ELR) physical layer (PHY) protocol data unit (PPDU) comprising a first preamble and a first data frame (ELR PPDU), the first ELR PPDU encoded by forward error correction (FEC) encoding, mapped to orthogonal frequency division multiplexing (OFDM) symbols, and duplicated multiple times over multiple resource units (RU) within a channel bandwidth, the initial transmission having a data rate of ˜3 Mbps or ˜1.5 Mbps, detect a first block acknowledgment (BA) frame indicating at least part of the initial transmission was not properly decoded and generate a first retransmission including a second ELR PPDU comprising a second preamble and a second data frame corresponding to the first data frame, the second preamble indicating the first retransmission to indicate that a receiver decoding the first retransmission combines soft bits stored from the initial transmission with soft bits from the first retransmission during decoding.

Other example embodiments are related to an apparatus having processing circuitry coupled to memory, wherein the processing circuitry is configured to detect an initial transmission including a first enhanced long range (ELR) physical layer (PHY) protocol data unit (PPDU) comprising a first preamble and a first data frame (ELR PPDU), the first ELR PPDU encoded by forward error correction (FEC) encoding, mapped to orthogonal frequency division multiplexing (OFDM) symbols, and duplicated multiple times over multiple resource units (RU) within a channel bandwidth, the initial transmission having a data rate of ˜3 Mbps or ˜1.5 Mbps, attempt to decode the initial transmission by calculating log-likelihood ratio (LLR) metrics for the initial transmission, when all or part of the initial transmission was not properly decoded, store the LLR metrics for all or part of the initial transmission and generate a first block acknowledgment (BA) frame indicating all or part of the initial transmission was not properly decoded, detect a first retransmission including a second ELR PPDU comprising a second preamble and a second data frame corresponding to the first data frame, the second preamble indicating the first retransmission and attempt to decode the first retransmission by combining the LLR metrics stored from the initial transmission with LLR metrics calculated for the first retransmission.

### BRIEF DESCRIPTION OF THE DRAWINGS

FIG. 1 shows a diagram for ELR PPDU encoding and decoding according to various example embodiments.

FIG. 2a shows a diagram for an ELR PPDU transmission comprising five LDPC CWs according to one example of these example embodiments.

FIG. 2b shows a diagram for a receiver storing information from the first ELR PPDU transmission of FIG. 2a.

FIG. 2c shows a diagram for an ELR PPDU retransmission including only the CWs that were unsuccessfully decoded in the initial transmission of FIG. 2a.

FIG. 2d shows a diagram for combining the LLRs calculated for the initial transmission with LLRs calculated for the retransmission of FIG. 2c.

FIG. 3a shows a diagram including an initial transmission comprising five LPDC codewords mapped to N OFDM symbols according to one example of these example embodiments.

FIG. 3b shows a diagram of the initial transmission of FIG. 3a.

FIG. 3c shows a diagram of chase combining LLRs stored for the initial transmission of FIG. 3b with LLRs calculated for a retransmission.

FIG. 4a shows a per AID TID information field for a MPDU ACK/NACK feedback according to various example embodiments.

FIG. 4b shows fields including the AID11 field, the ACK type field and the TID field from the per AID TID info field of FIG. 4a for the MPDU ACK/NACK feedback.

FIG. 4c shows a per AID TID information field for LDCP CW feedback according to various example embodiments.

FIG. 5 shows a table summarizing an analysis of ELR retransmissions using ARQ and ELR retransmissions using HARQ-CC according to one example.

FIG. 6a shows a method for ELR PPDU retransmissions at a transmitter side with HARQ-CC according to various example embodiments.

FIG. 6b shows a method for ELR PPDU retransmissions at a receiver side with HARQ-CC according to various example embodiments.

FIG. 7 shows an example network arrangement according to various example embodiments.

FIG. 8 shows an example ELR device according to various example embodiments.

### DETAILED DESCRIPTION

The example embodiments may be further understood with reference to the following description and the related appended drawings, wherein like elements are provided with the same reference numerals. The example embodiments relate to operations for supporting enhanced long range (ELR) communications in a wireless local area network (WLAN). In particular, the example embodiments describe a transmission (Tx) and reception (Rx) scheme for supporting retransmissions (ReTx) with chase combining (CC). The example embodiments describe medium access control (MAC) layer and physical (PHY) layer operations for an ELR transmitter for transmitting a PHY protocol data unit (PPDU) with retransmissions and an ELR receiver for decoding the retransmitted PPDU by combining log-likelihood ratio (LLR) metrics for the retransmitted PPDU with the LLRs for the initial PPDU to improve the decoding performance.

The example embodiments are described with regard to a WLAN. A person of ordinary skill in the art would understand that WLAN may refer to a network that operates in accordance with any of a plurality of different types of Institute of Electrical and Electronics Engineers (IEEE) 802.11 wireless communication protocols. The example embodiments are described with reference to the developing 802.11bn standard, e.g., ultra-high reliability (UHR). However, the example embodiments may also be applied as an upgrade to other 802.11 communication protocols such as, 802.11a, 802.11b, 802.11g, 802.11n, 802.11ac, 802.11ax, 802.11be, etc. or other wireless protocols. The WLAN may operate in several different frequency bands of the radio frequency (RF) spectrum. For example, the operating frequencies may include but are not limited to, the 900 megahertz (MHz), 2.4 gigahertz (GHz), 3.6 GHz, 4.9 GHZ, 5 GHZ, 5.9 GHZ, 6 GHZ, 60 GHZ bands, etc. Each band may include a plurality of channels. However, any reference to a WLAN, a particular communication protocol or a particular frequency band is for illustrative purposes. The example embodiments apply to any type of network that supports packet-based communication over links between devices.

The example embodiments are described with regard to a station (STA) communicating with an access point (AP) as these terms are defined in 802.11. However, the example embodiments may apply to wireless communications between any two 802.11 capable devices, e.g., a STA communicating with another STA in peer to peer communications.

Updates made to the 802.11 standard are formulated such that devices operating according to newer specifications may be backward compatible with earlier versions of the standard. This backward compatibility extends to the medium access control (MAC) layer of the 802.11 protocol architecture. The various 802.11 standards may differ with regard to the physical (PHY) layer.

In 802.11 standards, the MAC layer may be divided into two sub-layers including the MAC sub-layer and the MAC management sub-layer. The MAC sub-layer receives MAC service data units (MSDU) containing IP packets from the logical link control (LLC) layer. The MAC sub-layer adds a MAC header to generate a MAC protocol data unit (MPDU) and sends the MPDU to the PHY layer.

The PHY layer may be divided into two sublayers including the physical layer convergence protocol (PLCP) sublayer and the physical medium dependent (PMD) sublayer. The PLCP comprises an adaptation layer that performs functions such as clear channel assessment (CCA) and constructing packets for processing by the PMD layer. The PMD sub-layer is responsible for modulation and coding and transmitting the encoded PPDU.

The PLCP takes a frame from the MAC sub-layer, e.g., a MPDU, and creates a PHY PDU (PPDU) by adding a preamble and PHY header. The PMD takes the PPDU and performs scrambling, forward error correction (FEC) encoding and modulation. The PMD then transmits the data as bits.

The example embodiments are also described with regard to forward error correction (FEC) encoding. FEC encoding adds redundancy bits (e.g., parity bits) to a data set (e.g., systematic bits) for error detection. FEC codes are defined by a coding rate that represents how much redundancy was added to the original data, commonly represented as a ratio of the number of systematic bits to the total number of bits (e.g., 1/2, 3/4, etc.). Types of FEC encoding used in the 802.11 standards include convolutional coding, Reed-Solomon coding (primarily used in 802.11b), and low-density parity-check (LPDC) coding. Binary convolutional coding (BCC) with orthogonal frequency division multiplexing (OFDM) refers to an error correction scheme in which the input data is fed into a series of shift registers and the output is combined based on predefined generator polynomials. The encoded bits are interleaved and mapped to OFDM symbols using a modulation scheme such as, e.g., BPSK, QPSK, 16-QAM, etc.

LPDC encoding with OFDM refers to an error correction scheme in which input pits are multiplied by a generator matrix (e.g., a sparse parity-check matrix) to produce a codeword that includes systematic bits and parity bits. The bits of the codeword are first modulated into BPSK, QPSK or higher order QAM symbols depending on assigned modulation, and then interleaved so that consecutive bits contained in consecutive QAM symbols are not mapped to adjacent OFDM subcarriers, referred to as “tones.” Each tone is modulated using a scheme such as, e.g., BPSK, QPSK, etc., and transmitted. LPDC decoding is an iterative process in which the receiver calculates log-likelihood ratio (LLR) metrics that provide soft information that is updated in each iteration until the algorithm converges, e.g., when the parity-check matrix at the decoder is satisfied, or until a maximum number of iterations is reached.

A resource unit (RU) refers to group of OFDM subcarriers (e.g., tones) that may be allocated to a single user for a data transmission. RUs may vary in size depending on the channel bandwidth and may include sizes such as, e.g., 26 tones, 52 tones, 106 tones, etc. In one illustrative example, for a 20 MHz bandwidth channel, there could be nine 26-tone RUs, four 52-tone RUs, etc. RUs may be dynamically assigned to different users to enable the efficient and flexible use of the available wireless spectrum.

The example embodiments are also described with regard to modulation schemes including Binary Phase Shift Keying (BPSK) and Quadrature Phase Shift Keying (QPSK). These modulation schemes use fewer bits relative to higher order modulation schemes such as Quadrature Amplitude Modulation (QAM) (e.g., 16-QAM, 64-QAM, 256-QAM), requiring a lower signal to noise (SNR) ratio for proper decoding and thus being more robust to noise and interference and being suitable for communication over longer distances. Each modulation scheme has a corresponding constellation for mapping encoded bits to a unique point in the constellation diagram. In BPSK, each bit is mapped to one of two possible points; in QPSK, each bit is mapped to one of four possible points; in 16-QAM, each group of four bits is mapped to one of 16 possible points; etc. To form OFDM symbols, the constellation-mapped points are grouped into OFDM subcarriers.

An 802.11 OFDM frame generally comprises a preamble (e.g., a PHY header) and a data field. The preamble signals necessary transmission parameters to the receiver. The preamble of the OFDM frame includes a first part that is a legacy preamble comprising a legacy short training field (L-STF), a legacy long training field (L-LTF) and a legacy signal field (L-SIG). The L-STF comprises an easily detectable waveform that a receiver uses for initial processes including start of packet detection, automatic gain control, and initial frequency offset and time synchronization. The L-LTF is used for channel estimation and improving time/frequency offset estimation. The L-SIG contains the transmission time of the packet. The preamble further includes a second part that depends on the 802.11 version in use, e.g., a higher throughput (HT) preamble, a very high throughput (VHT) preamble, a high efficiency (HE) preamble, etc.

The example embodiments are also described with regard to chase combining. Chase combining refers to a specific type of error correction technique involving the retransmission of data packets wherein received versions of the packet are stored and combined to improve the probability of correct decoding. The combining may comprise methods such as weighted averaging, maximum ratio combining, or LLR combining. In LLR combining, the LLR values of the received bits from different transmissions are summed.

Enhanced long range (ELR) PPDU has been introduced in 802.11bn to ensure reliable UL transmissions due to UL/DL Tx power imbalance, and a few data rates below MCSO (6 Mbps) are proposed for the ELR PPDU. Considering the characteristics of long range communications, modulation schemes including BSPK and QPSK were proposed. It was agreed that data rates of ˜1.5 Mbps and ˜3 Mbps may be achieved by duplicating BSPK/QPSK modulated symbols (rate 1/2 FEC code) four times over four 52-tone resource units (RU) within a 20 MHz bandwidth PPDU.

At the receiver side, LLRs are calculated for each of the four duplicated code bits and combined for SNR enhancement. Frequency diversities may be further harvested with LLR combining for fading channel. Considered one way, this scheme is similar to chase combining within a single transmission.

It is noted that the ELR PPDU may include an ELR preamble that includes new ELR fields including, e.g., ELR-STF, ELR-LTF and ELR-SIG. These fields may provide enhanced channel estimation and further frequency offset correction and indicate necessary transmission information for the ELR PPDU, as described in greater detail below. In particular, ELR-SIG may indicate whether the PPDU is a first transmission or a retransmission.

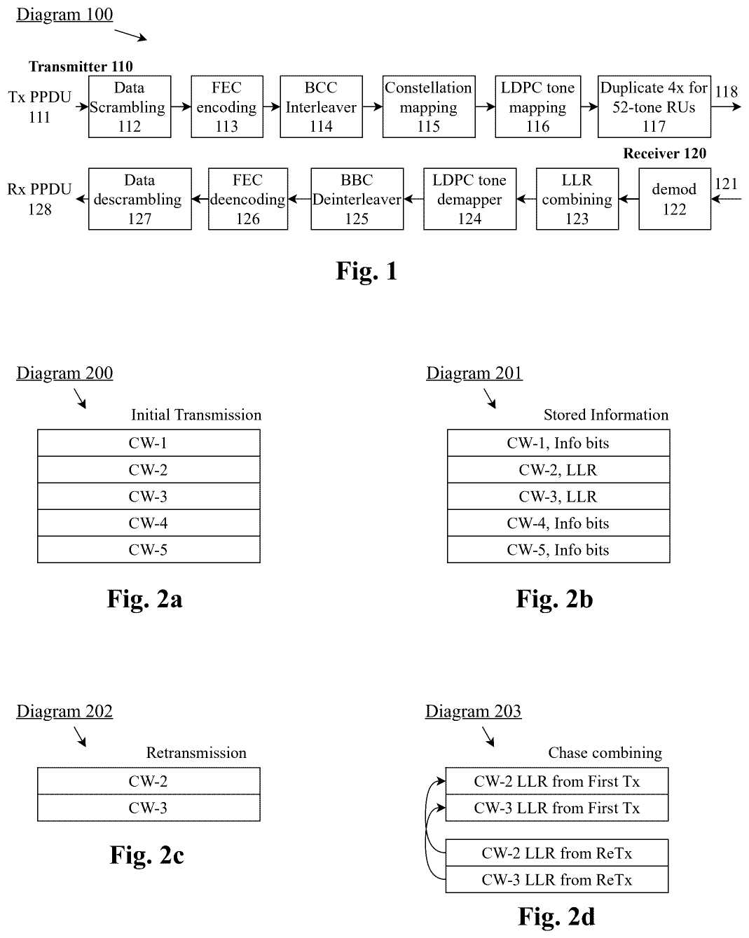

FIG. 1 shows a diagram 100 for ELR PPDU encoding and decoding according to various example embodiments. The diagram 100 includes a transmitter 110 and a receiver 120. In this example, the transmitter 110 corresponds to a PMD sublayer of a PHY layer of an ELR transmitting entity (e.g., a STA or an AP) and the receiver 120 corresponds to a PMD sublayer of a PHY layer of an ELR receiving entity (e.g., a STA or an AP).

The transmitter 110 receives a Tx ELR PPDU 111 from the PLCP sub-layer. In 112, scrambling is performed to randomize the data pattern. In 113, FEC encoding is applied. In some embodiments, binary convolutional coding (BCC) is used, while in other embodiments, low-density parity check (LDPC) encoding is used. When BCC is used, in 114, BCC interleaving is performed. In 115, constellation mapping is performed wherein the encoded (and interleaved) bits are mapped onto points in a constellation diagram depending on the modulation scheme used. When LPDC is used, in 116, tone mapping is performed to interleave the bits so that consecutive bits are not mapped to adjacent OFDM subcarriers. In 117, the OFDM symbols are modulated by BSPK/QPSK at a coding rate of 1/2 and duplicated four times over four 52-tone RUs. In 118, the modulated data is transmitted over the air.

In 121, the receiver 120 detects the data transmission. In 122, demodulation is performed. In 123, LLRs are calculated and combined for the duplicated OFDM symbols. When the LLRs converge, the transmission may be decoded. In 124, when LDPC is used, LDPC tone demapping is performed. In 125, when BCC is used, BCC deinterleaving is performed. In 126, FEC decoding is performed based on the combined LLRs. In 127, data descrambling is performed. The receiver 120 passes the Rx PPDU 128 to the PLCP sub-layer. The PLCP sub-layer may pass the PPDU 128 to the MAC layer for further processing. For LDPC encoded packet, data descrambling 127 and passing PPDU 128 to MAC layer may be skipped if all LDPC codewords are not successfully decoded in some embodiments.

According to various example embodiments described herein, operations are described for ELR PPDU retransmissions with chase combining. ELR PPDU ReTx with chase combining is a natural extension of the ELR Tx scheme described above, with significant benefits compared to ReTx with simple Type 1 HARQ used in current WiFi standards. For ˜1.5 Mbps data rate ReTx, LLR combining gain provided by chase combining may be further boosted to improve the reliability of the lowest data rate and reduce the number of retransmissions. For ˜3 Mbps data rate, combining of first Tx LLRs and ReTx LLRs is equivalent to lowering the data rate to ˜1.5 Mbps without doubling transmission duration for the same amount of data. Due to the small amount of data transmitted in ELR PPDU, even with maximum allowed PPDU duration, storing LLR data at the receiver side may be feasible even for the STA but especially for the AP.

Since ELR STAs either have Tx power limit or experience large path losses, some intra-BSS STAs cannot detect the signals from ELR STAs, resulting in collisions. Thus, it is desirable to reduce the number of retransmissions and retransmission durations from those ELR STAs. By implementing chase combining for ELR PPDU retransmissions, a higher SNR combining gain may be achieved and fewer retransmissions and/or a shorter duration for retransmissions are required relative to simple Type 1 HARQ retransmissions.

In the following, the chase combining scheme proposed for 802.11 ELR may be referred to as hybrid automatic repeat request (HARQ) chase combining (HARQ-CC). It should be understood that HARQ refers to a combination of FEC and ARQ. HARQ comprises a core feature of cellular standards (e.g., 5G New Radio) and the term HARQ may be commonly interpreted to refer to the HARQ mechanism of these standards. However, it should be understood that the term HARQ is not limited to any particular wireless technology and may be implemented in a variety of different technologies. Accordingly, the term “HARQ” or “HARQ-CC” as used herein with reference to 802.11 ELR should not be construed as referring to HARQ mechanisms implemented in other technologies (e.g., HARQ structure with 8 ms round trip (3 ms Tx processing and 3 ms Rx processing) in 3GPP) or as similar to HARQ mechanisms implemented in other technologies.

In various aspects of these example embodiments, operations are described for both the ELR transmitter and the ELR receiver. It should be understood that the ELR transmitter may comprise an 802.11 entity such as, e.g., a STA or an AP, and the ELR receiver may comprise an 802.11 entity such as, e.g., a STA or an AP. Various embodiments are related to PHY-level processing and some embodiments are related to MAC-level processing.

Various embodiments are described with regard to the ELR transmitter supporting HARQ-CC retransmissions including embodiments related to, e.g., signaling details; storing bits from an initial transmission (e.g., at an intermediate stage of processing) to save some data processing for retransmissions; FEC encoding details including supported coding schemes (e.g., BCC and LPDC), and pre-FEC padding; modulation details including BCC interleaving, LPDC tone mapping, and post-FEC padding; ACK/NACK reception (e.g., for LDPC CWs); and retransmitting only part of the initial transmission corresponding to LPDC codewords that were not successfully decoded by the receiver.

Various embodiments are described with regard to the ELR receiver supporting HARQ-CC retransmissions including embodiments related to, e.g., signaling details; FEC decoding details; demodulation details; storing log-likelihood ratio (LLR) metrics for unsuccessfully decoded transmissions/CWs and/or decoded bits for successfully decoded CWs; ACK/NACK transmission (e.g., for LDPC CWs); and PHY/MAC information exchange.

To be described in greater detail below, with HARQ-CC, the transmitter may either retransmit the entire packet sent in the first transmission for simplicity or only transmit the failed LDPC codewords (CWs) in HARQ retransmissions. It is noted that in scenarios where, e.g., only failed LDPC CWs are retransmitted, even when there is available bandwidth, aggregating a new MPDU in an aggregated MPDU (AMPDU) retransmission should be avoided for the ELR PPDU. The ELR PPDU may transmit at most 1125 bytes and 2250 bytes at data rate 1.5 Mbps and 3 Mbps in one transmission, respectively. It is preferable to retransmit only failed MPDUs to ensure faster delivery.

In ELR PPDU ReTx with HARQ-CC, the following two options may be implemented for the PHY transmitter with regard to storing transmission bits. There is a tradeoff between the two options with regard to memory requirements and data processing requirements. In a first option, the transmitter may store some bits from an initial transmission (e.g., at an intermediate stage of processing) to save some data processing requirements. In a second option, the transmitter does not store any bits from the initial transmission.

In the first option, the transmitter may store the FEC output code bits from an initial transmission for retransmissions. In this option, some data processing is reduced for retransmissions including for pre-FEC padding, data scrambling, and FEC coding.

In general, the transmitter may store this data until it is determined that the packet was received correctly (e.g., receiving an ACK for the PPDU) or after a maximum number of allowed retransmissions is reached, at which time the transmitter will release the memory. In some cases, the transmitter may discard the stored code bits before the packet is received correctly or the maximum number of allowed retransmissions is reached. For example, the transmitter may discard the stored bits if other types of MAC frames or more urgent data packet(s) having a higher priority need to be transmitted.

In a second option, the transmitter does not store any FEC output after each transmission. In this option, the transmitter repeats the PPDU encoding process using the same scramble seed as the first transmission and sends the entire packet, or part of the packet, in a retransmission, to be described in detail below. If the first transmission is 3 Mbps and the retransmission is 1.5 Mbps, or if only part of the packet is retransmitted, some minor changes are required for post-FEC padding, to be described in detail below.

Some scenarios require changes in the pre-FEC and post-FEC padding processes for HARQ retransmission. In some cases, padding is added before the FEC encoding to ensure that the data frame size matches the required input size for the FEC encoder. In some cases, padding is added after the FEC encoding to ensure that the encoded data frame size matches the requirements for modulation and transmission. If certain Tx parameters change between the initial transmission and retransmissions then padding will have to be adjusted as well.

Various terms and parameters are relevant to FEC encoding as follows. The term N_{pld} refers to a number of payload bits. The term N_{DBPS} refers to a number of data bits per OFDM symbol. The term N_{CBPS} refers to a number of coded bits per OFDM symbol. The term N_{avbits} refers to a number of available bits, i.e., a number of FEC output code bits. The term Nₛₕᵣₜ refers to a number of shortening bits in LDPC CWs. The term N_{punc} refers to a number of punctured bits in LDPC CWs. The term N_{sym} refers to a number of OFDM symbols of the PPDU. The a factor refers to pre-FEC padding factor, which indicates that OFDM symbol segment boundary within the last OFDM symbol where FEC output code bit ends.

In one scenario, the first transmission is sent at 3 Mbps and the second transmission is lowered to 1.5 Mbps. The total number of input bits to the FEC encoder may be different (for some payload size, N_{pld}, may have 6 bits difference due to different N_{DBPS} and N_{CBPS} for 1.5 Mbps and 3 Mbps) even if the entire packet is retransmitted.

In order to have the same FEC output code bits (e.g., the same N_{pld}, N_{avbits}, Nₛₕᵣₜ and Nou punc values) for the transmitter which repeats all data processing for the retransmissions, it shall use the N_{DBPS} and N_{CBPS} corresponding to the first transmission data rate for pre-FEC padding and calculating LDPC parameters (e.g., if LDPC extra segment is added, N_{avbits} is added by N_{DBPS,short} (the number of data bits per OFDM symbol segment) of the first transmission data rate) for the following retransmissions regardless of the data rate for retransmissions. For N_{sym} and ‘a’ factor values set in ELR-SIG, they are calculated based on N_{DBPS}, N_{DBPS,short}, N_{CBPS} and N_{CBPS,short} of the retransmission data rate. To provide one illustrative example, N_{CBPS}=96, N_{CBPS,short}=24 for 3 Mbps data rate and N_{CBPS}=48, N_{CBPS,short}=12 for 1.5 Mbps data rate.

If only failed LDPC CWs (which are less than the number of CWs in the first transmission) are included in the retransmission, or if the first transmission data rate is 3 Mbps and the retransmission data rate (including entire packet) is 1.5 Mbps, N_{sym} and ‘a’ factor values will be different than the values set in the first transmission. Furthermore, the end of retransmitted LDPC CWs may not align with OFDM symbol segment boundary indicated by the ‘a’ factor. This may be addressed according to either of the following two options.

In a first option, the last LPDC CW is repeated to align with the OFDM symbol segment boundary indicated by the ‘a’ factor. For 3 Mbps data rate, each segment has 24 bits; for 1.5 Mbps data rate, each segment has 12 bits. In a second option, post-FEC padding bits are added right after the end of the retransmitted LDPC CWs.

For a BCC encoded packet, N_{avbits} is always twice of N_{pld} for both data rates. If the first transmission data rate is 3 Mbps and the retransmission data rate (including entire packet) is 1.5 Mbps, N_{sym} and ‘a’ factor will be different than the values set in the first transmission. If the end of the BCC encoder output bits in the retransmission is not aligned with the OFDM segment indicated by the ‘a’ factor, post-FEC padding bits are added right after the last code bit.

At the receiver side, the receiver may store LLR statistics of coded bits to combine LLRs from the first transmission and the following retransmissions. In general, the receiver will release the memory after the PPDU is decoded correctly or the maximum number of allowed retransmissions is reached. If the packet is indicated as a first transmission in ELR-SIG, the receiver will release the stored LLR even if the previous PPDU is not received correctly and the maximum number of allowed retransmissions is not reached.

After decoding each transmission (including first Tx and HARQ ReTx), the receiver stores only the LLR statistics corresponding to failed CWs, e.g., those CWs that cannot be converged. For the successfully converged CWs, in some embodiments, the receiver may store the decoded information bits for the successfully decoded CWs. In some embodiments, PHY may not need to store successfully decoded information bits after forwarding to MAC.

FIG. 2a shows a diagram 200 for an ELR PPDU transmission comprising five LDPC CWs according to one example of these example embodiments. In this example, the receiver attempts to decode the five LDPC CWs, e.g., CW-1, CW-2, CW-3, CW-4 and CW-5. In this example, CW-1, CW-4 and CW-5 are decoded correctly (e.g., the LLR values converge such that CW may be decoded successfully), and CW-2 and CW-3 are not decoded correctly (e.g., there is no LLR convergence when a maximum number of iterative decoding attempts is reached, such that the CW cannot be decoded successfully).

FIG. 2b shows a diagram 201 for a receiver storing information from the first ELR PPDU transmission of FIG. 2a. In its PHY memory, the receiver stores the information bits for the successfully decoded CWs (CW-1, CW-4 and CW-5) and stores the LLR statistics for the unsuccessfully decoded CWs (CW-2 and CW-3).

In another aspect of these example embodiments, to further improve ReTx efficiency, the receiver may feedback LDPC CW ACK/NACK information besides BA. The transmitter may then transmit only failed LDPC CWs in retransmissions. For data rate ˜1.5 Mbps, up to 10 LDPC CWs may be transmitted. The memory requirement is at most 11.25k bytes (90k bits assuming 5 bits for each LLR). For data rate ˜3 Mbps, up to 19 LDPC CWs may be transmitted. The memory requirement is at most 22.5k bytes (180k bits assuming 5 bits for each LLR).

The LDPC CW ACK/NACK bitmap may be set in the Multi-STA BA along with BA bitmap using the same STA AID or a special AID, to be described in detail below.

The transmitter will transmit only the failed LDPC CWs based on the LDPC CW bitmap set in multi-STA BA in HARQ retransmission. The transmitter may lower the data rate to ensure a reliable transmission of the failed LDPC CWs while fitting within a single transmission.

Referring back to FIG. 2a, the receiver may feedback an LPDC CW bitmap within a multi-STA block acknowledgment (BA), to be described in greater detail below. In the example of FIG. 2a, where CW-2 and CW-3 were unsuccessful, the LPDC CW bitmap could comprise {10011000}, the fields of the bitmap corresponding to the CWs in sequential order with a ‘1’ indicating a successful decoding of the corresponding CW and a ‘0’ indicating an unsuccessful decoding of the corresponding CW.

FIG. 2c shows a diagram 202 for an ELR PPDU retransmission including only the CWs that were unsuccessfully decoded in the initial transmission of FIG. 2a. The transmitter may retransmit only CW-2 and CW-3.

FIG. 2d shows a diagram 203 for combining the LLRs calculated for the initial transmission with LLRs calculated for the retransmission of FIG. 2c. At the receiver, after the retransmission is demodulated by the receiver and LLRs are calculated, the receiver may attempt to combine the LLRs corresponding to CW-2 and CW-3.

If the entire packet is retransmitted even though only part of the LDPC CWs have failed (e.g., transmitter and/or receiver do not support LDPC ACK/NACK feedback), the receiver may choose one of the following two options for data portion processing in implementation.

In a first option, the receiver demodulates the entire packet and compute LLRs for all LDPC CW, but only combines the LLRs for failed LDPC CWs.

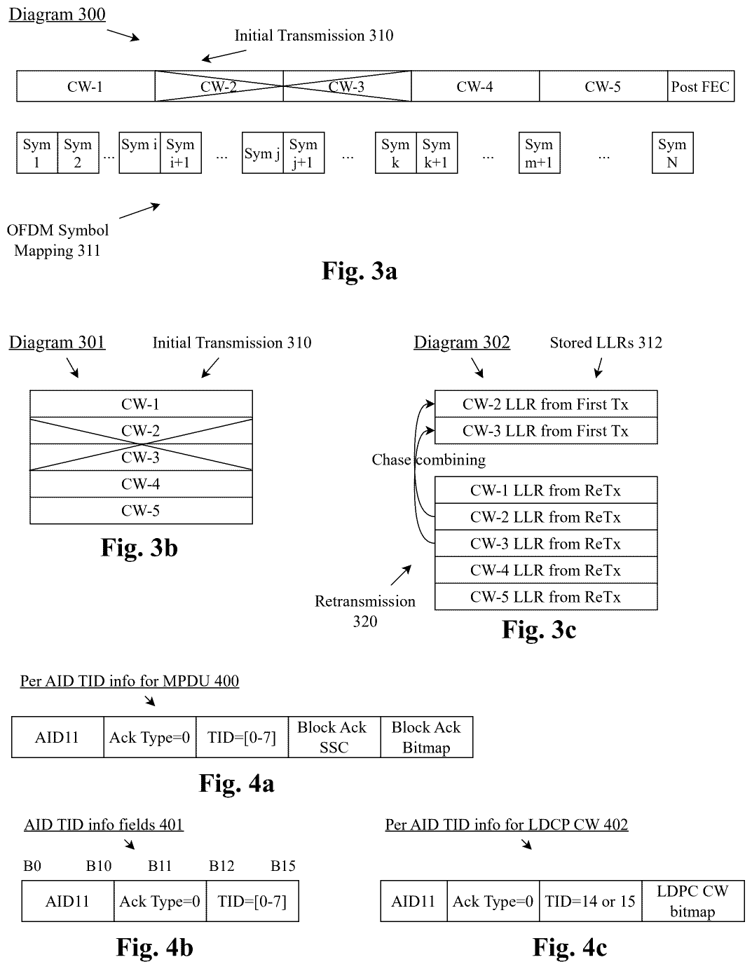

FIG. 3a shows a diagram 300 including an initial transmission 310 comprising five LPDC codewords mapped to N OFDM symbols 311 according to one example of these example embodiments. In this example, five LPDC codewords and post-FEC padding are mapped to Symbols 1-N. CW-1 overlaps with symbols 1-i+1; CW-2 overlaps with symbol i+1 to symbol j+1; CW-3 overlaps with symbol j+1 to symbol k+1; CW-4 overlaps with symbol k+1 to symbol m+1; CW-5 overlaps with symbol m+1 to symbol N; post-FEC padding fills out symbol N.

FIG. 3b shows a diagram 301 of the initial transmission of FIG. 3a. In this example, CW-2 and CW-3 were not successfully decoded. The receiver stores LLRs for CW-2 and CW-3.

FIG. 3c shows a diagram 302 of chase combining LLRs 112 stored for the initial transmission 310 of FIG. 3b with LLRs calculated for a retransmission 320. In this example, the retransmission 320 includes the entire packet (e.g., CWs 1-5). In this example, the receiver demodulates the entire packet and computes LLRs for all LDPC CWs. The receiver then combines the stored LLRs 112 with the corresponding LLRs of the retransmission 320, e.g., CW-2 and CW-3.

In a second option, the receiver skips demodulating the OFDM symbols within successfully decoded LDPC CWs. Each LDPC CW spreads over approximately 38 OFDM symbols for 1.5 Mbps and approximately 20 OFDM symbols for 3 Mbps. The receiver demodulates only the OFDM symbols overlapped with the failed LDPC CWs, then combines the LLR for failed LDPC CWs.

Referring back to FIG. 3a, the receiver may skip demodulating data tones in symbols {1 to i}. For these symbols, the receiver may track the phase using pilot tones. The receiver will demodulate symbols {i+1 to k+1}, and combine the LLRs corresponding to CWs 2 and 3 before decoding. This may require storing a lookup table (LUT) to indicate the symbol boundaries for demodulating. For both options, successfully decoded CWs are not required to be decoded again.

In another aspect of these example embodiments, operations for ACK/NACK feedback are described. In particular, embodiments are directed to LDPC CW feedback included in a multi-station block acknowledgement (Multi-STA BA) frame.

The BA frame generally carries ACK/NACK information for the ARQ process ongoing at the MAC layer. The BA frame may include a number of fields such as a frame control field; a duration field; a receive address (RA) field; a transmitter address (TA) field; a BA Control field; a BA information field comprising a Starting Sequence Control subfield and a BlockAck Bitmap subfield; and a frame check sequence (FCS) field. The Multi-STA BlockAck frame includes the frame control field; the duration field; the RA field; the TA field; the BA Control field; and a BA information subfield for per association identifier (AID) traffic identifier (TID) information. The BA information field of the Multi-STA BA frame comprises one or more Per AID TID Info subfields.

FIG. 4a shows a per AID TID information subfield 400 for a MPDU ACK/NACK feedback according to various example embodiments. This expanded subfield may include an AID11 subfield, an AckType subfield, a TID subfield, a BA Starting Sequence Control subField, and a Block Ack Bitmap subfield. Starting from the per AID TID info subfield 400 for the MPDU, a per AID TID information subfield for LDCP CW feedback may be designed.

FIG. 4b shows fields 401 including the AID11 subfield, the ACK type subfield and the TID subfield from the per AID TID info subfield 400 of FIG. 4a for the MPDU ACK/NACK feedback. These subfields 401 span 2 octets.

FIG. 4c shows a per AID TID information subfield 402 for LDCP CW feedback according to various example embodiments. This expanded subfield may include an AID11 field, an AckType subfield, a TID subfield and a LDPC CW bitmap subfield.

For LDPC CW feedback, AID11 may be either STA AID (matching RA) or a special AID for feedback types other than BA. ACK type and TID values may use one of the reserved entries in Multi-STA BA. For LDPC feedback, the Block Ack SCC field is not present, since the receiver may not be able to decode any data portion. The LDPC CW bitmap is 4 octets.

If the Multi-STA BA is not received by the transmitter, the transmitter will retransmit the entire failed packet and indicate it is the first transmission in ELR-SIG, and receiver will discard stored LLR statistics upon receiving the ELR-SIG. If the receiver may only decode up to ELR-SIG, not the data portion, the receiver will still send Multi-STA BA frame including only Per AID TID Info subfield for LDPC CW.

When HARQ-CC retransmission is enabled for the LDPC encoded packet, two options of information exchanges between PHY and MAC interface may be considered.

In a first option, only when all LDPC CWs are received correctly, PHY forwards the decoded information bits to MAC. Otherwise, PHY forwards only LDPC CW Bitmap to MAC to construct the Multi-STA BA. This option may save time/power consumption for MAC processing.

In a second option, PHY may forward both decoded information bits and LDPC bitmap to MAC. This option may be helpful if there are more than one MPDU in the packet sent at 3 Mbps and fewer than half of the LDPC CWs are failed. In this case, the transmitter may use type 1 HARQ retransmission with ˜1.5 Mbps data rate.

If the packet is BCC encoded (only one CW using BCC), Multi-STA BlockAck frame is not used for feedback even if HARQ retransmission is enabled. No changes are required for information exchanges between the PHY and MAC interface (PHY forward all information bits to MAC after decoding process, and MAC will construct BlockAck after MAC processing).

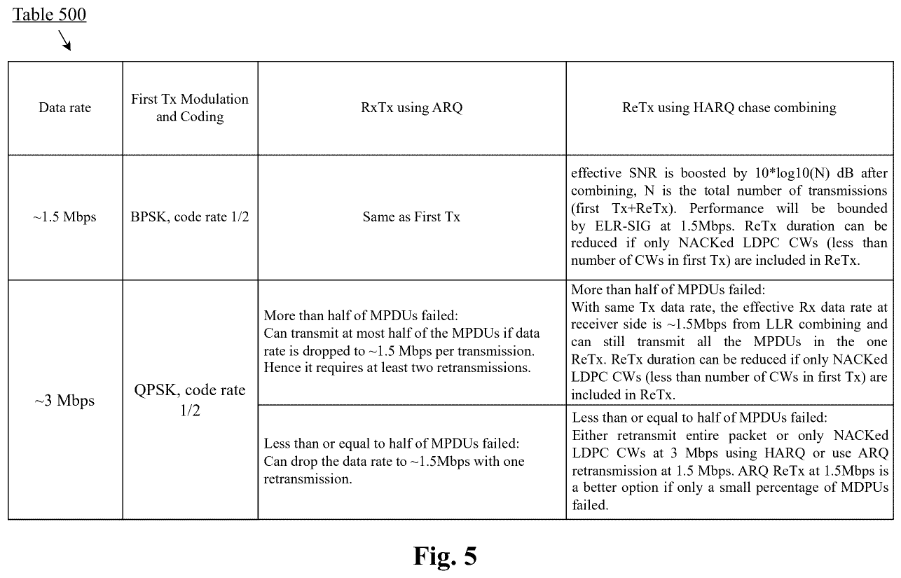

HARQ chase combining may reduce the frequency of ELR STAs to contend the channel and occupy a long Tx Duration when the PPDU is failed, as shown in the table below. FIG. 5 shows a table 500 summarizing an analysis of ELR retransmissions using type 1 HARQ and ELR retransmissions using HARQ-CC according to one example.

For the ELR ˜1.5 Mbps data rate, BPSK modulation was used at a code rate of 1/2. The retransmission performance using only type 1 HARQ was comparable to the initial transmission performance. The retransmission performance using HARQ-CC was improved. The effective SNR was boosted by 10*log 10 (N) dB after combining, where N is the total number of transmissions (first Tx+ReTx). Performance will be bounded by packet detection and ELR-SIG decoding at 1.5 Mbps. The ReTx duration may be reduced when only NACKed LDPC CWs (less than number of CWs in first Tx) are included in the retransmission.

For the ELR ˜3 Mbps data rate, QPSK modulation was used at a code rate of 1/2. For type 1 HARQ retransmissions, when more than half of the MPDUs failed, the transmitter may retransmit at most half of the MPDUs if data rate is dropped to ˜1.5 Mbps per transmission. Hence it requires at least two retransmissions. For HARQ-CC retransmissions, with the same Tx data rate, the effective Rx data rate at receiver side is ˜1.5 Mbps from LLR combining and may still transmit all the MPDUs in the one ReTx. The ReTx duration may be reduced if only NACKed LDPC CWs (less than number of CWs in first Tx) are included in ReTx.

For Type 1 HARQ retransmissions, when less than half of the MPDUs failed, the data rate may be dropped to ˜1.5 Mbps with one retransmission. For STA supporting HARQ-CC retransmissions, the transmitter may either retransmit the entire packet or transmit only NACKed LDPC CWs at 3 Mbps using HARQ-CC or use Type 1 HARQ retransmission at 1.5 Mbps. Type 1 HARQ ReTx at 1.5 Mbps is a better option if only a small percentage of MDPUs failed.

In another aspect of these example embodiments, to further exploit frequency diversity gain when the entire PPDU is retransmitted, the coded bits of a retransmission may be interleaved with some variations from the first transmission and preceding retransmissions.

The LDPC tone mapping may comprise

$$t ( k ) = {D}_{T M} * ( mod ( k , \frac{{N}_{S D}}{{D}_{T M}} ) ) + [ \frac{k * {D}_{T M}}{{N}_{S D}} ]$$

in the first transmission. For the following retransmission, the mapping equation may be modified based on the number of retransmissions, e.g.,

$${t}_{i} ( k ) = {D}_{T M} * ( mod ( k , \frac{{N}_{S D}}{{D}_{T M}} ) ) + [ \frac{k * {D}_{T M} + i * {N}_{S D}}{{N}_{S D}} ] ,$$

for the i-th retransmission.

If only NAcked LDPC CWs (less than the number of CWs in first Tx) are retransmitted, the frequency diversity may be achieved without any change on LDPC tone mapping in the retransmissions.

For BCC interleaving, the permutation is

$$t ( k ) = {N}_{R O W} * mod ( k , {N}_{C O L} ) + [ \frac{k}{{N}_{C O L}} ]$$

in the first Tx (the second and third permutations are not needed for BSPK/QPSK 1SS transmission). For the following ReTx, the permutation may be modified based on the number of retransmissions, e.g.,

$${t}_{i} ( k ) = {N}_{R O W} * mod ( k , {N}_{C O L} ) + mod ( [ \frac{k}{{N}_{C O L}} ] + i , {N}_{R O W} )$$

for the i-th retransmission.

In another aspect of these example embodiments, signaling details are described. To enable HARQ-CC retransmission for ELR PPDU, one bit field “HARQ-CC operation” and two bits field “transmission version” are included in UHR ELR-SIG. For Type 1 HARQ ReTx, both “HARQ-CC operation” and “transmission version” are set to 0 to indicate it is not HARQ-CC retransmission. For HARQ-CC ReTx, “HARQ-CC operation” is set to 1, and “transmission version” is set to the number of transmission for this packet. The receiver will use “transmission version” to interpret BCC interleaver or LDPC tone mapper variations. For first transmission and Type 1 HARQ ReTx, the “transmission version” field is always set to 0.

When HARQ-CC retransmission is enabled, if “transmission version” indicates first Tx, receiver will discard the stored LLR even if the previous packet is not received correctly and the maximum number of allowed retransmission has not been reached.

If the packet is BCC encoded, if “transmission version” indicates HARQ-CC retransmissions, the receiver will extract same number of coded bits as in the first transmission and combine the corresponding LLRS.

If the packet is LDPC encoded, the receiver will extract the number of NAcked LDPC CWs for LLR combining if it has sent a Multi-STA BA right before receiving this retransmission, and the receiver will extract all the LDPC CWs included in the first transmission if it has not sent a response (no BA is sent if all LDPC CWs are failed) or has sent a compressed BA (e.g., a BA only including MPDU ACK/NACK bitmap) right before receiving the retransmission.

In another option, the “HARQ-CC operation” bit is not included in the signaling. If STA indicates the HARQ-CC support in the management frame (e.g., beacon, or frames including OMI subfield), it will always store LLR after demodulation. If the “transmission version” is set to 0 in ELR-SIG of the received packet, the receiver will discard the stored LLR data, and replace with the LLR of the latest received packet. If the transmission version is set to 1 in ELR-SIG of the received packet, the receiver will attempt to use chase combining to decode the retransmission.

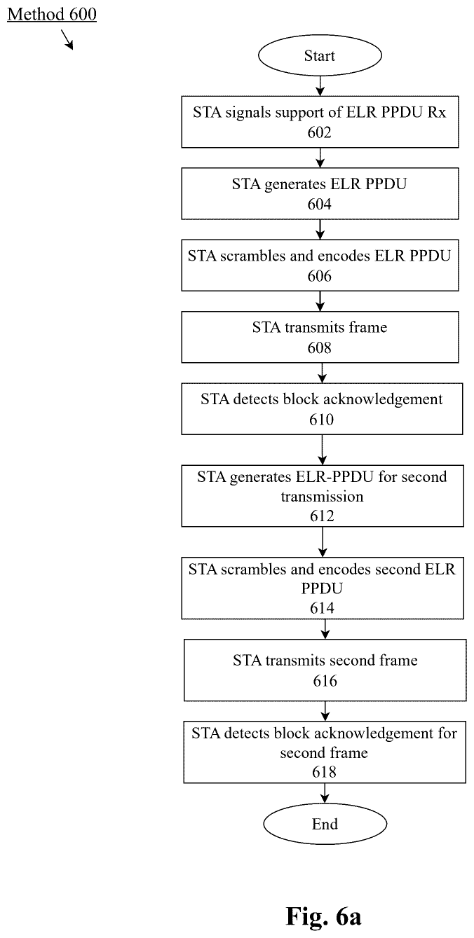

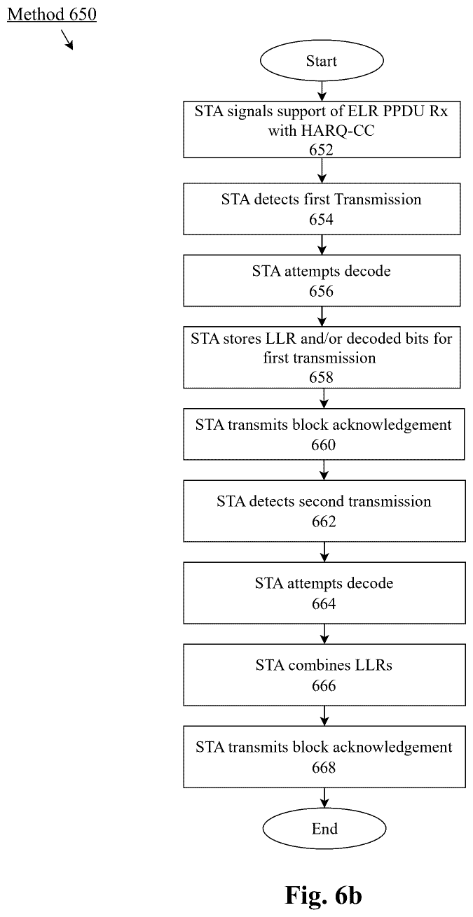

FIG. 6a shows a method 600 for ELR PPDU retransmissions with HARQ-CC at a transmitter side according to various example embodiments. The method 600 is described from the perspective of a STA transmitting the ELR PPDU to an AP. 602, the STA signals support of ELR PPDU Rx with HARQ-CC.

In 604, the PLCP sub-layer of the PHY transmitter of the STA generates an ELR PPDU by adding a preamble including fields for ELR support. This is the first transmission of the ELR PPDU, such that ELR-SIG in the preamble indicates a first transmission. If both the “HARQ-CC operation” field and the “transmission version” field are included in the ELR-SIG, both fields are set to ‘0’ to indicate the PPDU is a Type 1 HARQ retransmission. The “HARQ-CC operation” field is set to 1 and the “transmission version” field is set to ‘0’ to indicate the PPDU is the first transmission of a HARQ-CC retransmission. If only the “transmission version” field is included in the ELR-SIG, this field is set to ‘0’ to indicate the first transmission for HARQ-CC retransmission or Type 1 HARQ transmission. The PLCP sub-layer passes the ELR PPDU to the PMD sub-layer of the PHY transmitter of the STA.

In 606, the PMD sub-layer of the PHY transmitter of the STA scrambles and encodes the ELR PPDU with FEC encoding and the encoded output bits are interleaved and mapped to OFDM symbols using a modulation scheme. The modulation and coding for the first transmission may comprise a 1/2 FEC code rate and BPSK or QPSK modulation. The modulated symbols are duplicated four times over four 52-tone RUs within a 20 MHz BW. The data rate for these modulation and coding schemes may be ˜1.5 Mbps or ˜3 Mpbs.

In some embodiments, the PHY transmitter may store the FEC output code bits for ReTx. In other embodiments, the PHY transmitter does not store the FEC output code bits for ReTx.

If LDPC encoding is used for FEC, then the FEC output comprises one or more LDPC codewords. The LDPC codewords are first modulated to BSPK/QPSK symbols and then mapped to OFDM symbols by LDPC tone mapping. The OFDM symbols corresponding to a 52-tone RU are duplicated four times over the four 52-tone RUs within the 20 MHz BW. If BCC encoding is used for FEC, the encoded bits are first interleaved, then modulated to BPSK/QPSK symbols before being mapped to OFDM symbols and duplicated.

In 608, the PMD sub-layer of the PHY transmitter of the STA transmits the encoded and modulated frame as bits over the air as a first transmission. In this example, the PMD sub-layer of the PHY receiver of the AP detects the first transmission and attempts to decode the first transmission.

In 610, the PHY transmitter of the STA detects a block acknowledgment (BA) frame from the PHY receiver of the AP. In this example, either the entire first transmission or one or more individual LDPC CWs were not decoded correctly.

If LDPC encoding was used for FEC, then the BA frame comprises a multi-STA BA frame. The multi-STA BA frame may include a LDPC CW ACK/NACK bitmap indicating which of the transmitted LDPC CWs were decoded correctly and which of the transmitted LDPC CWs were not decoded correctly.

If BCC encoding was used for FEC, then the BA frame comprises a compressed BA frame.

It is noted that, if the PHY transmitter of the STA does not receive the multi-STA BA frame, the PHY transmitter will retransmit the entire packet and indicate it as a first transmission in ELR-SIG.

In 612, the PLCP sub-layer of the PHY transmitter of the STA generates an ELR PPDU for a second transmission (first retransmission) comprising the same data frame (e.g., a same MPDU) as the first transmission. This is the first retransmission of the ELR PPDU, such that ELR-SIG in the preamble indicates a retransmission. If both the “HARQ-CC operation” field and the “transmission version” field are included in the ELR-SIG, the HARQ-CC operation field is set to ‘1’ to indicate PPDU is a HARQ retransmission. The transmission version indicates the number of transmissions for the packet. In this example, the transmission version field is set to ‘1’ to indicate the second transmission (first retransmission). It is noted that if LDPC encoding was used for the first transmission in 606, and the PHY transmitter did not receive a multi-STA BA frame 610, then the HARQ-CC operation field is set to ‘1’ and the transmission version field is set to ‘0’. If only the “transmission version” field is included in the ELR-SIG, this field is set to ‘1’. The PLCP sub-layer passes the ELR PPDU to the PMD sub-layer of the PHY transmitter of the STA.

In 614, the PMD sub-layer of the PHY transmitter of the STA scrambles and encodes the ELR PPDU with FEC encoding and the encoded output bits are interleaved and mapped to OFDM symbols using a modulation scheme. In some embodiments, the data rate for the second transmission is the same as that of the first transmission, e.g., ˜1.5 Mbps or ˜3 Mbps. In some embodiments, the data rate for the second transmission is less than that of the first transmission, e.g., drops from ˜3 Mbps to ˜1.5 Mbps.

If LDPC encoding was used, and the BA frame in 610 indicates that some of the LDPC CWs were decoded correctly and other LDPC CWs were not decoded correctly, then the PHY transmitter may determine whether to retransmit the entire packet or only the LDPC CWs that were not decoded correctly.

If the data rate for the second transmission is the same as that of the first transmission, and if all LDPC CWs are being retransmitted, then the PHY transmitter may use stored FEC output code bits for the ReTx (if this was stored by the transmitter).

If the data rate for the second transmission is less than that of the first transmission or if less than all of the LDPC CWs are being retransmitted, then the total number of input bits to the FEC encoder may be different than that of the first transmission. In these scenarios, pre-FEC padding bits must be added to the input bits same as the first transmission such that the second transmission will have the same FEC output code bits as the first transmission. Additionally, the Nsym and a factor may be different than the values used for the first transmission. In these scenarios, some code bits in the last LDPC CW may be repeated to align with the OFDM symbol segment boundary indicated by the a factor or post-FEC padding bits are added right after the end of the retransmitted LDPC CWs.

For BCC encoding, if the end of the BCC encoder output bits is not aligned with the OFDM segment indicated by the a factor, post-FEC padding bits are added.

If the entire PPDU is retransmitted, the coded bits may be interleaved with some variations, e.g., by LDPC tone mapping with a modified mapping equation or by BCC interleaving with a modified permutation.

In 616, the PMD sub-layer of the PHY transmitter of the STA transmits the encoded and modulated frame as bits over the air as a second transmission (first retransmission). In this example, the PMD sub-layer of the PHY receiver of the AP detects the second transmission and attempts to decode the PPDU by chase combining with stored LLRs of the first transmission.

In 618, the PHY transmitter of the STA detects a block acknowledgment (BA) frame from the PHY receiver of the AP. In this example, the BA indicates the entire PPDU was decoded correctly.

FIG. 6b shows a method 650 for ELR PPDU retransmissions with HARQ-CC at a receiver side according to various example embodiments. The method 650 is described from the perspective of a STA receiving the ELR PPDU from an AP. In 652, the STA signals support of ELR PPDU Rx with HARQ-CC.

In 654, the PMD sub-layer of the PHY receiver of the STA detects a first transmission.

In 656, the PMD sub-layer of the PHY receiver of the STA attempts to decode the first transmission. In this example, the PHY receiver decodes the ELR-SIG of the preamble of the first transmission. The ELR-SIG indicates a first transmission (e.g., by setting “HARQ-CC operation” set to ‘1’ and “transmission version” to ‘0’ or by setting “transmission version” to ‘0’). The PMD sub-layer demodulates the first transmission and calculates LLRs for the first transmission for combining across the four duplicates.

If LDPC encoding was used for FEC, then the PHY receiver calculates LLRs for one or more LDPC CWs. In this example, either all or some of the LDPC CWs are not decoded correctly by LLR combining.

If BCC encoding is used for FEC, then the PHY receiver calculates LLRs for the first transmission. In this example, the first transmission is not decoded correctly by LLR combining.

In 658, the PHY receiver stores bits for the first transmission. If LDPC encoding was used for FEC, and some of the LDPC CWs were decoded correctly, then the PHY receiver stores only the LLRs for the CWs that were not decoded correctly. For the CWs that were decoded correctly, the PHY receiver stores the information bits. If BCC encoding was used for FEC, then the PHY receiver stores the LLRs for the first transmission.

In 660, the PHY receiver of the STA transmits a block acknowledgment (BA) frame indicating the individual LDPC CWs that were not decoded correctly (in a multi-STA BA frame) or the first transmission was not decoded correctly.

In 662, the PMD sub-layer of the PHY receiver of the STA detects a second transmission.

In 664, the PMD sub-layer of the PHY receiver of the STA attempts to decode the second transmission. In this example, the PHY receiver decodes the ELR-SIG of the preamble of the second transmission. The ELR-SIG indicates a second transmission (first retransmission) (e.g., by setting “HARQ-CC operation” to ‘1’ and “transmission version to ‘1’ or by setting “transmission version” to ‘1’).

If LDPC encoding was used for FEC, and some of the LDPC CWs were decoded correctly in the first transmission, the transmitter may retransmit the whole packet or only the failed LDPC CWs. If the transmitter retransmits the whole packet, the PHY receiver may demodulate the entire packet or may skip demodulating the OFDM symbols within successfully decoded LDPC CWs. The PMD sub-layer demodulates some or all of the second transmission and calculates LLRs for some or all of the second transmission.

In 666, the PHY receiver of the STA attempts to combine the LLRs from the previously failed CW(s) by chase combining. In this example, the LLRs converge for all the LDPC CWs and the packet is successfully decoded.

In 668, the PHY receiver of the STA transmits a BA frame indicating the second transmission was decoded correctly.

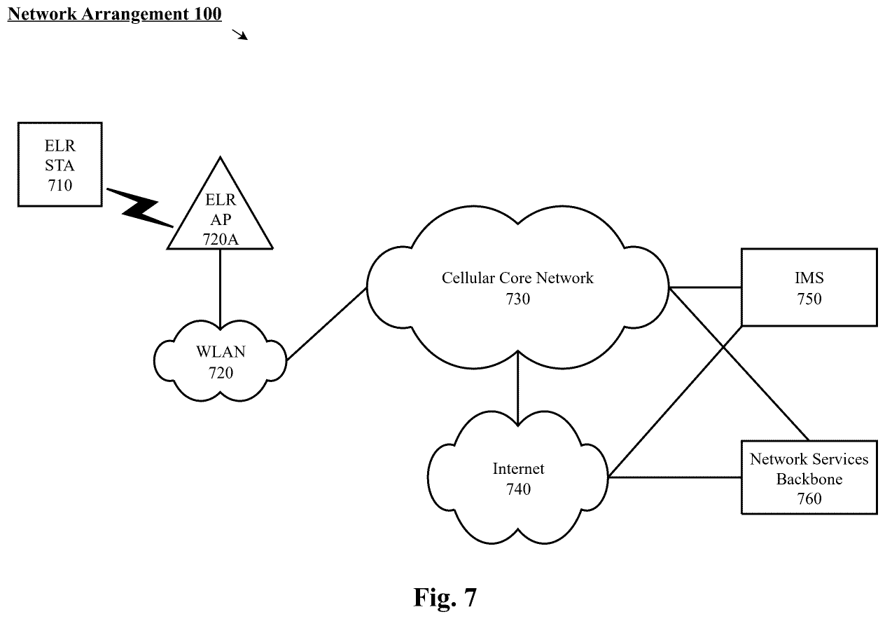

FIG. 7 shows an example network arrangement 700 according to various example embodiments. The example network arrangement 700 includes an ELR STA 710. Those skilled in the art will understand that the STA 710 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of STAs being used by any number of users. Thus, the example of a single STA 710 is merely provided for illustrative purposes.

Further, the example network arrangement 700 includes a wireless local access network (WLAN) 720. However, the STA 710 may also communicate with other types of networks and the STA 710 may also communicate with networks over a wired connection. Therefore, the STA 710 may include a WLAN chipset to communicate with the WLAN 720 and any of a plurality of further chipsets to communicate with other types of networks (e.g., 5G new radio (NR) radio access network (RAN), Long-Term Evolution (LTE) RAN, Legacy RAN, etc.).

The WLAN 720 may include any type of wireless local area network (WiFi, Hot Spot, soft AP, IEEE 802.11 networks, etc.). As described above, the example embodiments are described with reference to the developing IEEE 802.11bn communication protocol. WLANs may manage access to the network via any of a plurality of different hardware devices that are configured to send and/or receive traffic from STAs that are equipped with the appropriate WLAN chipset. In the example network arrangement 700, the STA 710 may connect to the WLAN 720 via an ELR access point (AP) 720A. However, reference to an AP is merely provided for illustrative purposes. The example embodiments may apply to any type of device that manages access to a WLAN.

In addition to the WLAN 720, the network arrangement 700 also includes a cellular core network 730, the Internet 740, an IP Multimedia Subsystem (IMS) 750, and a network services backbone 760. The cellular core network 730 may be considered to be the interconnected set of components that manages the operation and traffic of a cellular network. The cellular core network 730 also manages the traffic that flows between the cellular network and the Internet 740. The IMS 750 may be generally described as an architecture for delivering multimedia services to the STA 710 using the IP protocol. The IMS 750 may communicate with the cellular core network 730 and the Internet 740 to provide the multimedia services to the STA 710. The network services backbone 760 is in communication either directly or indirectly with the Internet 740 and the cellular core network 730. The network services backbone 760 may be generally described as a set of components (e.g., servers, network storage arrangements, etc.) that implement a suite of services that may be used to extend the functionalities of the STA 710 in communication with the various networks.

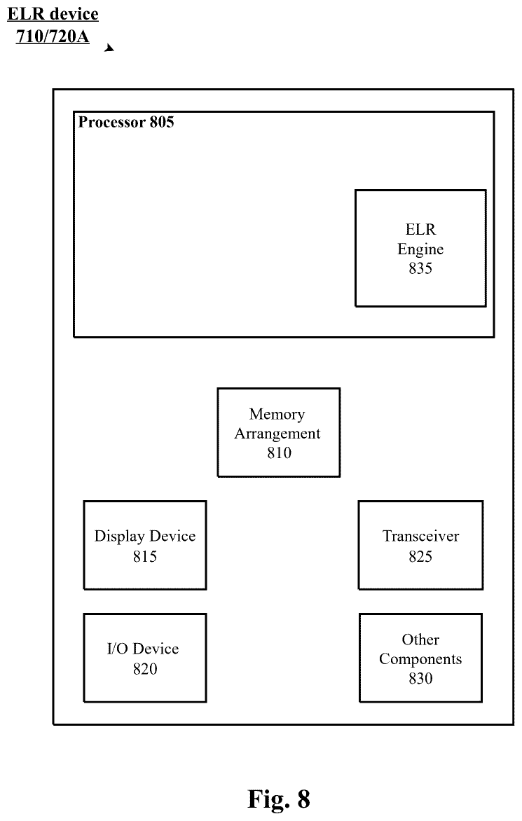

FIG. 8 shows an example ELR device 710/720A according to various example embodiments. That is, the device described with respect to FIG. 8 may represent the STA 710 and/or the AP 720A. Those skilled in the art will understand that the STA 710 and the AP 720A may include the same components or may have some variance in the components between the devices. The device 710/720A will be described with regard to the network arrangement 700 of FIG. 1. The device 710/720A may represent any electronic device and may include a processor 805, a memory arrangement 810, a display device 815, an input/output (I/O) device 820, a transceiver 825, and other components 830. The other components 830 may include, for example, an audio input device, an audio output device, a battery, a constant power supply, a data acquisition device, ports to electrically connect the multilink device 710/720A to other electronic devices, sensors to detect conditions of the multilink device 710/720A, etc.

The processor 805 may be configured to execute a plurality of engines of the ELR device 710/720A. For example, the processor 805 may execute an ELR engine 835. The ELR engine 835 may perform various functionalities associated with the ELR communications for the ELR device 710/720A, as described in detail above. The multilink engine 835 being an application (e.g., a program) executed by the processor 805 is only example. The functionality associated with the ELR engine 835 may also be represented as a separate incorporated component of the multilink device 710/720A or may be a modular component coupled to the multilink device 710/720A, e.g., an integrated circuit with or without firmware. For example, the integrated circuit may include input circuitry to receive signals and processing circuitry to process the signals and other information. The engine may be embodied as one application or separate applications. In addition, in some ELR devices 710/720A, the functionality described for the processor 805 is split among two or more processors such as a baseband processor and an applications processor. The example embodiments may be implemented in any of these or other configurations of an ELR device 710/720A.

The memory arrangement 810 may be a hardware component configured to store data related to operations performed by the ELR device 710/720A. The display device 815 may be a hardware component configured to show data to a user while the I/O device 820 may be a hardware component that enables the user to enter inputs. The display device 815 and the I/O device 820 may be separate components or integrated together such as a touchscreen. The transceiver 825 may be a hardware component configured to establish a connection with the WLAN 720. Accordingly, the transceiver 825 may operate on a variety of different frequencies or channels (e.g., set of consecutive frequencies) as described above.

### EXAMPLES

In a first example, a method, comprising generating an initial transmission including a first enhanced long range (ELR) physical layer (PHY) protocol data unit (PPDU) comprising a first preamble and a first data frame (ELR PPDU), the first ELR PPDU encoded by forward error correction (FEC) encoding, mapped to orthogonal frequency division multiplexing (OFDM) symbols, and duplicated multiple times over multiple resource units (RU) within a channel bandwidth, the initial transmission having a data rate of ˜3 Mbps or ˜1.5 Mbps, detecting a first block acknowledgment (BA) frame indicating at least part of the initial transmission was not properly decoded and generating a first retransmission including a second ELR PPDU comprising a second preamble and a second data frame corresponding to the first data frame, the second preamble indicating the first retransmission to indicate that a receiver decoding the first retransmission combines soft bits stored from the initial transmission with soft bits from the first retransmission during decoding.

In a second example, the method of the first example, wherein the first preamble includes a first ELR-SIG and the second preamble includes a second ELR-SIG, the first ELR-SIG indicating no retransmission and the second ELR-SIG indicating the first retransmission.

In a third example, the method of the second example, wherein the first and second ELR-SIG each comprise a first field to indicate whether hybrid automatic repeat request with chase combining (HARQ-CC) retransmissions are enabled and a second field to indicate a number of transmissions of the ELR PPDU.

In a fourth example, the method of the second example, further comprising indicating support of ELR PPDU hybrid automatic repeat request with chase combining (HARQ-CC) retransmissions, wherein the first and second ELR-SIG each comprise a field to indicate whether the associated ELR PPDU is a retransmission.

In a fifth example, the method of the first example, further comprising storing one or more output bits of the FEC encoding of the first ELR PPDU in the initial transmission and avoiding data processing including pre-FEC padding, data scrambling, and FEC encoding for the second ELR PPDU in the first retransmission.

In a sixth example, the method of the first example, further comprising performing the FEC encoding of the second ELR PPDU in the first retransmission using a same scramble seed as that used for the first ELR PPDU in the initial transmission.

In a seventh example, the method of the first example, further comprising, when a data rate for the second ELR PPDU is different from a data rate for the first ELR PPDU, adding a same number of pre-FEC padding bits to the second ELR PPDU as pre-FEC padding bits that were added to the first ELR PPDU.

In an eighth example, the method of the seventh example, wherein a total number of input bits to the FEC encoding for the second ELR PPDU is different from the total number of input bits to the FEC encoding for the first ELR PPDU when the data rate for the first retransmission is lower than the data rate for the initial transmission.

In a ninth example, the method of the first example, further comprising, when a number of OFDM symbols or an OFDM symbol segment boundary for the first retransmission is different from a number of OFDM symbols or an OFDM symbol segment boundary for the initial transmission, repeating a last low density parity check (LDPC) codeword in the first retransmission to align with the OFDM symbol segment boundary.

In a tenth example, the method of the first example, further comprising, when a number of OFDM symbols or an OFDM symbol segment boundary for the first retransmission is different from a number of OFDM symbols or an OFDM symbol segment boundary for the initial transmission, adding post-FEC padding bits after an end of retransmitted low density parity check (LDPC) codewords or binary convolutional coding (BCC) bits.

In an eleventh example, the method of the first example, wherein the first BA frame comprises a multi-station BA frame including a per association identifier (AID) traffic identifier (TID) information subfield for low density parity check (LDPC) codeword feedback.

In a twelfth example, the method of the eleventh example, further comprising detecting in the per AID TID information subfield an AID subfield indicating a station AID or a special AID, an ACK type subfield indicating a reserved entry, and a TID subfield indicating a reserved entry.

In a thirteenth example, the method of the eleventh example, further comprising detecting in the LDPC codeword feedback that one or more first LDPC codewords were decoded correctly and one or more second LDPC codewords were not decoded correctly.

In a fourteenth example, the method of the thirteenth example, wherein the first retransmission includes only the one or more second LDPC codewords that were not decoded correctly.

In a fifteenth example, the method of the thirteenth example, wherein the first retransmission includes both the one or more first LDPC codewords that were decoded correctly and the one or more second LDPC codewords that were not decoded correctly.

In a sixteenth example, the method of the first example, wherein the first retransmission is interleaved with a modified mapping equation for low density parity check (LDPC) tone mapping or a modified permutation for binary convolutional coding (BCC) relative to the initial transmission.

In a seventeenth example, the method of the first example, wherein the ELR PPDU is interleaved to prevent consecutive bits contained in consecutive QAM symbols being mapped to adjacent OFDM subcarriers.

In an eighteenth example, a processor configured to perform any of the methods of the first through seventeenth examples.

In a nineteenth example, an enhanced long range (ELR) device configured to perform any of the methods of the first through seventeenth examples.

In a twentieth example, a method, comprising detecting an initial transmission including a first enhanced long range (ELR) physical layer (PHY) protocol data unit (PPDU) comprising a first preamble and a first data frame (ELR PPDU), the first ELR PPDU encoded by forward error correction (FEC) encoding, mapped to orthogonal frequency division multiplexing (OFDM) symbols, and duplicated multiple times over multiple resource units (RU) within a channel bandwidth, the initial transmission having a data rate of ˜3 Mbps or ˜1.5 Mbps, attempting to decode the initial transmission by calculating log-likelihood ratio (LLR) metrics for the initial transmission, when all or part of the initial transmission was not properly decoded, storing the LLR metrics for all or part of the initial transmission and generating a first block acknowledgment (BA) frame indicating all or part of the initial transmission was not properly decoded, detecting a first retransmission including a second ELR PPDU comprising a second preamble and a second data frame corresponding to the first data frame, the second preamble indicating the first retransmission and attempting to decode the first retransmission by combining the LLR metrics stored from the initial transmission with LLR metrics calculated for the first retransmission.

In a twenty first example, the method of the twentieth example, wherein the first preamble includes a first ELR-SIG and the second preamble includes a second ELR-SIG, the first ELR-SIG indicating no retransmission and the second ELR-SIG indicating the first retransmission.

In a twenty second example, the method of the twenty first example, wherein the first and second ELR-SIG each comprise a first field to indicate whether hybrid automatic repeat request with chase combining (HARQ-CC) retransmissions are enabled and a second field to indicate a number of transmissions of the ELR PPDU.

In a twenty third example, the method of the twenty first example, further comprising indicating support of ELR PPDU hybrid automatic repeat request with chase combining (HARQ-CC) retransmissions in a management frame and storing the LLR metrics by default until an ELR-SIG is received indicating the associated ELR PPDU is not a retransmission.

In a twenty fourth example, the method of the twentieth example, wherein the first BA frame comprises a multi-station BA frame including a per association identifier (AID) traffic identifier (TID) information subfield for low density parity check (LDPC) codeword feedback.

In a twenty fifth example, the method of the twenty fourth example, further comprising including in the per AID TID information subfield an AID subfield indicating a station AID or a special AID, an ACK type subfield indicating a reserved entry, and a TID subfield indicating a reserved entry.

In a twenty sixth example, the method of the twenty fourth example, further comprising including in the LDPC codeword feedback that one or more first LDPC codewords were decoded correctly and one or more second LDPC codewords were not decoded correctly.

In a twenty seventh example, the method of the twenty sixth example, further comprising forwarding to a medium access control (MAC) entity the LDPC codeword feedback and do not forward any properly decoded information bits to MAC until all LDPC codewords are decoded correctly.

In a twenty eighth example, the method of the twenty sixth example, further comprising forwarding to a medium access control (MAC) entity the LDPC codeword feedback and any properly decoded information bits prior to all LDPC codewords being decoded correctly.

In a twenty ninth example, the method of the twenty sixth example, wherein the first retransmission includes only the one or more second LDPC codewords that were not decoded correctly.

In a thirtieth example, the method of the twenty sixth example, wherein the first retransmission includes both the one or more first LDPC codewords that were decoded correctly and the one or more second LDPC codewords that were not decoded correctly.

In a thirty first example, the method of the thirtieth example, further comprising demodulating the first retransmission in its entirety and compute LLR metrics for all LDPC codewords and combining only the LLR metrics for the one or more second LDPC codewords that were not decoded correctly.

In a thirty second example, the method of the thirtieth example, further comprising demodulating the first retransmission while skipping demodulating OFDM symbols within successfully decoded LDPC codewords and combining only the LLR metrics for the one or more second LDPC codewords that were not decoded correctly.

In a thirty third example, the method of the twentieth example, wherein the ELR PPDU is interleaved to prevent consecutive bits contained in consecutive QAM symbols being mapped to adjacent OFDM subcarriers.

In a thirty fourth example, a processor configured to perform any of the methods of the twentieth through thirty third examples.

In a thirty fifth example, an enhanced long range (ELR) device configured to perform any of the methods of the twentieth through thirty third examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry coupled to memory, wherein the processing circuitry is configured to:
generate an initial transmission including a first enhanced long range (ELR) physical layer (PHY) protocol data unit (PPDU) comprising a first preamble and a first data frame (ELR PPDU), the first ELR PPDU encoded by forward error correction (FEC) encoding, mapped to orthogonal frequency division multiplexing (OFDM) symbols, and duplicated multiple times over multiple resource units (RU) within a channel bandwidth, the initial transmission having a data rate of ˜3 Mbps or ˜1.5 Mbps;
detect a first block acknowledgment (BA) frame indicating at least part of the initial transmission was not properly decoded; and
generate a first retransmission including a second ELR PPDU comprising a second preamble and a second data frame corresponding to the first data frame, the second preamble indicating the first retransmission to indicate that a receiver decoding the first retransmission combines soft bits stored from the initial transmission with soft bits from the first retransmission during decoding.

2. The apparatus of claim 1, wherein the first preamble includes a first ELR-SIG and the second preamble includes a second ELR-SIG, the first ELR-SIG indicating no retransmission and the second ELR-SIG indicating the first retransmission.

3. The apparatus of claim 2, wherein the first and second ELR-SIG each comprise a first field to indicate whether hybrid automatic repeat request with chase combining (HARQ-CC) retransmissions are enabled and a second field to indicate a number of transmissions of the ELR PPDU.

4. The apparatus of claim 2, the processing circuitry further configured to:
indicate support of ELR PPDU hybrid automatic repeat request with chase combining (HARQ-CC) retransmissions,
wherein the first and second ELR-SIG each comprise a field to indicate whether the associated ELR PPDU is a retransmission.

5. The apparatus of claim 1, the processing circuitry further configured to:
store one or more output bits of the FEC encoding of the first ELR PPDU in the initial transmission; and
avoid data processing including pre-FEC padding, data scrambling, and FEC encoding for the second ELR PPDU in the first retransmission.

6. The apparatus of claim 1, the processing circuitry further configured to:
when a data rate for the second ELR PPDU is different from a data rate for the first ELR PPDU, add a same number of pre-FEC padding bits to the second ELR PPDU as pre-FEC padding bits that were added to the first ELR PPDU.

7. The apparatus of claim 6, wherein a total number of input bits to the FEC encoding for the second ELR PPDU is different from the total number of input bits to the FEC encoding for the first ELR PPDU when the data rate for the first retransmission is lower than the data rate for the initial transmission.

8. The apparatus of claim 1, the processing circuitry further configured to:
when a number of OFDM symbols or an OFDM symbol segment boundary for the first retransmission is different from a number of OFDM symbols or an OFDM symbol segment boundary for the initial transmission, repeat a last low density parity check (LDPC) codeword in the first retransmission to align with the OFDM symbol segment boundary.

9. The apparatus of claim 1, the processing circuitry further configured to:
when a number of OFDM symbols or an OFDM symbol segment boundary for the first retransmission is different from a number of OFDM symbols or an OFDM symbol segment boundary for the initial transmission, add post-FEC padding bits after an end of retransmitted low density parity check (LDPC) codewords or binary convolutional coding (BCC) bits.

10. The apparatus of claim 1, wherein the first BA frame comprises a multi-station BA frame including a per association identifier (AID) traffic identifier (TID) information subfield for low density parity check (LDPC) codeword feedback.

11. The apparatus of claim 10, the processing circuitry further configured to:
detect in the per AID TID information subfield an AID subfield indicating a station AID or a special AID, an ACK type subfield indicating a reserved entry, and a TID subfield indicating a reserved entry.

12. The apparatus of claim 10, the processing circuitry further configured to:
detect in the LDPC codeword feedback that one or more first LDPC codewords were decoded correctly and one or more second LDPC codewords were not decoded correctly.

13. The apparatus of claim 12, wherein the first retransmission includes only the one or more second LDPC codewords that were not decoded correctly.

14. The apparatus of claim 12, wherein the first retransmission includes both the one or more first LDPC codewords that were decoded correctly and the one or more second LDPC codewords that were not decoded correctly.

15. An apparatus comprising processing circuitry coupled to memory, wherein the processing circuitry is configured to:
detect an initial transmission including a first enhanced long range (ELR) physical layer (PHY) protocol data unit (PPDU) comprising a first preamble and a first data frame (ELR PPDU), the first ELR PPDU encoded by forward error correction (FEC) encoding, mapped to orthogonal frequency division multiplexing (OFDM) symbols, and duplicated multiple times over multiple resource units (RU) within a channel bandwidth, the initial transmission having a data rate of ˜3 Mbps or ˜1.5 Mbps;
attempt to decode the initial transmission by calculating log-likelihood ratio (LLR) metrics for the initial transmission;
when all or part of the initial transmission was not properly decoded, store the LLR metrics for all or part of the initial transmission and generate a first block acknowledgment (BA) frame indicating all or part of the initial transmission was not properly decoded;
detect a first retransmission including a second ELR PPDU comprising a second preamble and a second data frame corresponding to the first data frame, the second preamble indicating the first retransmission; and
attempt to decode the first retransmission by combining the LLR metrics stored from the initial transmission with LLR metrics calculated for the first retransmission.

16. The apparatus of claim 15, wherein the first preamble includes a first ELR-SIG and the second preamble includes a second ELR-SIG, the first ELR-SIG indicating no retransmission and the second ELR-SIG indicating the first retransmission.

17. The apparatus of claim 16, wherein the first and second ELR-SIG each comprise a first field to indicate whether hybrid automatic repeat request with chase combining (HARQ-CC) retransmissions are enabled and a second field to indicate a number of transmissions of the ELR PPDU.

18. The apparatus of claim 16, the processing circuitry further configured to:
indicate support of ELR PPDU hybrid automatic repeat request with chase combining (HARQ-CC) retransmissions in a management frame; and
store the LLR metrics by default until an ELR-SIG is received indicating the associated ELR PPDU is not a retransmission.

19. The apparatus of claim 15, wherein the first BA frame comprises a multi-station BA frame including a per association identifier (AID) traffic identifier (TID) information subfield for low density parity check (LDPC) codeword feedback.

20. The apparatus of claim 19, the processing circuitry further configured to:
include in the per AID TID information subfield an AID subfield indicating a station AID or a special AID, an ACK type subfield indicating a reserved entry, and a TID subfield indicating a reserved entry.
